(19) United States
(12) Patent Application Publication
(10) Pub. No.: US 2007/0291518 A1
(43) Pub. Date: Dec. 20, 2007

(54) CONVERTER HAVING A DAMPING CONTROL CIRCUIT

(75) Inventor: DIETER ECKARDT, Herzogenaurach (DE)

Correspondence Address: HENRY M FEIEREISEN, LLC, 350 FIFTH AVENUE, SUITE 4714, NEW YORK, NY, 10118, US

(73) Assignee: Siemens Aktiengesellschaft, Munchen (DE)

(21) Appl. No.: 11/755,330

(22) Filed: May 30, 2007

(30) Foreign Application Priority Data
May 30, 2006 (DE) 10 2006 025 110.5

(51) Int. Cl. H02M 1/12

(52) U.S. Cl. 363/41

(57) ABSTRACT

A converter (34) includes a control device (6) connected at its output to a pulse width modulator (8), which is connected on the output side to control inputs of a load-side inverter (10), and a current measuring device (4), which is connected on the input side to two terminals of the load-side inverter (10), and on the output side to two measurement inputs of the control device (6). Further provided is a two-channel damping control circuit (38), whose control-circuit channels (56, 58) are each connected on the input side to an output of the current measuring device (4), and on the output side to an inverting adder (54), and the outputs of the two control-circuit channels (56, 58) and the output of the inverting adder (54) are connected to inputs of the pulse width modulator (8). As a result, a converter (34) is realized that can actively dampen a connected undamped inverter output-filter (36) without causing an additional control dead time.

### CROSS-REFERENCES TO RELATED APPLICATIONS

This application claims the priority of German Patent Application, Serial No. 10 2006 025 110.5, filed May 30, 2006, pursuant to 35 U.S.C. 119(a)-(d), the content of which is incorporated herein by reference in its entirety as if fully set forth herein.

### BACKGROUND OF THE INVENTION

The invention relates, in general, to a converter.

Nothing in the following discussion of the state of the art is to be construed as an admission of prior art.

FIG. 1 shows a converter 2 of a type involved here. In this diagram, 4 denotes a current measuring device, 6 a control device, 8 a pulse width modulator and 10 a load-side pulse-controlled inverter. The AC-side outputs of the load-side pulse-controlled inverter 10 are connected by lines 12, 14 and 16 to a respective output U, V and W of the converter 2. The lines 12 and 16 contain a respective current transformer 18 and 20, which are connected on the output side to a respective input of the current measuring device 4, in particular an integrating current measuring device. The inverter output currents i_{L1} and i_{L3} are measured by means of these two current transformers 18 and 20. Current-proportional signals u_{iL1} and u_{iL3} are determined by the integrating current measuring device 4 from these measured inverter output currents i_{L1} and i_{L3}, and are taken to a respective measurement input of the control device 6. Based on these current-proportional signals u_{iL1} and u_{iL3} and at least one preset setpoint value, a speed setpoint value n*, for example, this control device 6, for example a field-oriented control device, calculates a control variable for a stator-voltage setpoint value uₛ* corresponding to the speed setpoint value n*. By means of the pulse width modulator 8, this control variable u_{S}* which is a voltage vector u in this diagram, is converted into control signals for the inverter valves of the load-side pulse-controlled inverter 10. A DC-link capacitor 22, across which there is a DC-link DC voltage U_{ZW}, is connected electrically in parallel with DC-side terminals of the pulse-controlled inverter 10. Thus, this converter 2 is a typical voltage source inverter, also known as a frequency converter.

In order to keep the inverter output currents i_{L1}, i_{L2} and i_{L3} generated by the converter 2 as free of harmonics as possible, an inverter output-filter 24 is used, which is connected on the input side to the outputs U, V and W of the converter 2, and on the output side to a load 26, for example an electric motor. An LC filter, in particular a symmetrically designed LC filter, is provided as the inverter output-filter 24. If the load 26 is connected to a typical converter 2 by means of unscreened motor cables 28, 30 and 32, for example, then an output filter 24 must be used. If low noise operation is required for such a drive comprising frequency converter 2 and load 26, then an output filter 24 is again advantageous.

FIGS. 2 and 3 each show a schematic diagram of an embodiment of an LC filter 24. In FIG. 2, the LC filter 24 is shown in a star connection, whilst in FIG. 3, this LC filter 24 is shown in a Delta connection. In a symmetrically designed LC filter 24, all the filter chokes L1, L2 and L3 and all the filter capacitors C1, C2 and C3 of the LC filter 24 have the same values in each case. Since operation of the drive may excite a resonant frequency of the LC filter 24, in particular where vector-controlled operation is used, typical inverter output-filters 24 comprise damping resistors R1, R2 and R3. These damping resistors R1, R2 and R3, however, dissipate heat even during normal operation of the drive, which must be removed as waste heat. As the switching frequency of the converter 2 increases, the overall size of the inverter output-filter 24 decreases, so that this filter 24 can be integrated in the inverter unit. This means that the heat dissipation of the damping resistors R1, R2 and R3 of the LC filter 24 is produced inside this inverter unit, thereby increasing the internal temperature of the inverter unit. To avoid damaging the signal electronics of the inverter, measures must be taken to prevent a substantial increase in the internal temperature of the inverter unit. Although integrating the inverter output-filter 24 in the inverter housing saves space and reduces wiring costs, the interior of the inverter unit must be cooled.

Typical converters 2, in particular standard converters, have a sampling frequency of, for example, 2-4 kHz for the current control system. Typical inverter output-filters 24 have a resonant frequency of 4 kHz, for example. For the control device 6 of the converter 2 to provide active damping of an inverter output-filter 24 having a resonant frequency of 4 kHz, it would need to work at a sampling rate of more than 8 kHz, with an ideal rate of 16 kHz for effective damping, which would mean multiplying the sampling rate for the current controller of typical converters 2 by a maximum factor of eight. Furthermore, an additional control dead time would be produced, which would conflict with effective damping of an inverter output-filter 24. In addition, the processor load would also be very high, which could only be reduced if a processor with a significantly higher clock frequency were to be used. This increases the manufacturing costs and hence the selling price of the inverter unit, however.

It would therefore be desirable and advantageous to provide an improved converter to obviate prior art shortcomings and to actively dampen an undamped inverter output-filter.

### SUMMARY OF THE INVENTION

According to one aspect of the present invention, a converter includes a control device connected at its output to a pulse width modulator, which is connected on the output side to control inputs of a load-side inverter, and a current measuring device, which is connected on the input side to two terminals of the load-side inverter, and on the output side to two measurement inputs of the control device, wherein a two-channel damping control circuit is provided, whose control-circuit channels are each connected on the input side to an output of the current measuring device, and on the output side to an inverting adder, and in that the outputs of the two control-circuit channels and the output of the inverting adder are connected to inputs of the pulse width modulator.

By providing a two-channel damping control circuit in the converter, which is arranged as an inner control loop of the converter control system, it can actively intervene in the control process without affecting the control device present in the converter. This arrangement of the two-channel damping control circuit means that it is decoupled from the converter control device, allowing a typical undamped LC filter to be used as the inverter output-filter.

In an advantageous embodiment of the converter, the two control-circuit channels of the damping control circuit each comprise an adjustable control loop gain. This has two advantages: the damping control circuit can be matched to an LC filter connected to the outputs of the inverter, and a required damping level can be achieved. In addition, the adjustable control loop gain of the damping control circuit can also be used to disable the latter.

In a further advantageous embodiment of the converter, each control-circuit channel of the damping control circuit comprises a controller that satisfies the following difference equation:
y(k)=−a·y(k−1)+u(k)−u(k−1) 0≦a≦1

When a=0.5, the controller in each control-circuit channel of the damping control circuit can have a particularly simple design so that it can be implemented in hardware. In addition, a voltage amplitude is thereby determined directly from a measured actual current value that can be superimposed on a voltage control variable of the control device of the converter, so that any resonant oscillation that arises can be damped for the currently active sampling step.

### BRIEF DESCRIPTION OF THE DRAWING

Other features and advantages of the present invention will be more readily apparent upon reading the following description of currently preferred exemplified embodiments of the invention with reference to the accompanying drawing, in which.

FIG. 1 shows an equivalent circuit of a typical drive comprising a typical converter, a typical damped output filter and a load;

FIG. 2 shows an equivalent circuit of a typical damped converter output-filter in a star connection;

FIG. 3 shows an equivalent circuit of such a damped converter output-filter in a Delta connection;

FIG. 4 shows an equivalent circuit of a drive containing a converter according to the invention and an undamped output filter;

FIG. 5 shows an equivalent circuit of a first embodiment of the damping control circuit according to the invention;

FIG. 6 shows an equivalent circuit of an implementation of a controller of the damping control circuit shown in FIG. 5; and

FIG. 7 shows an equivalent circuit of a second embodiment of the damping control circuit according to the invention.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

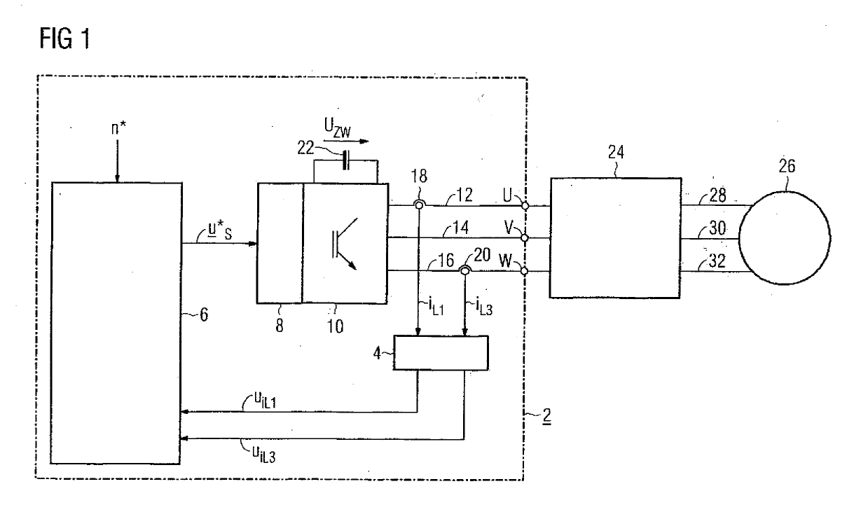

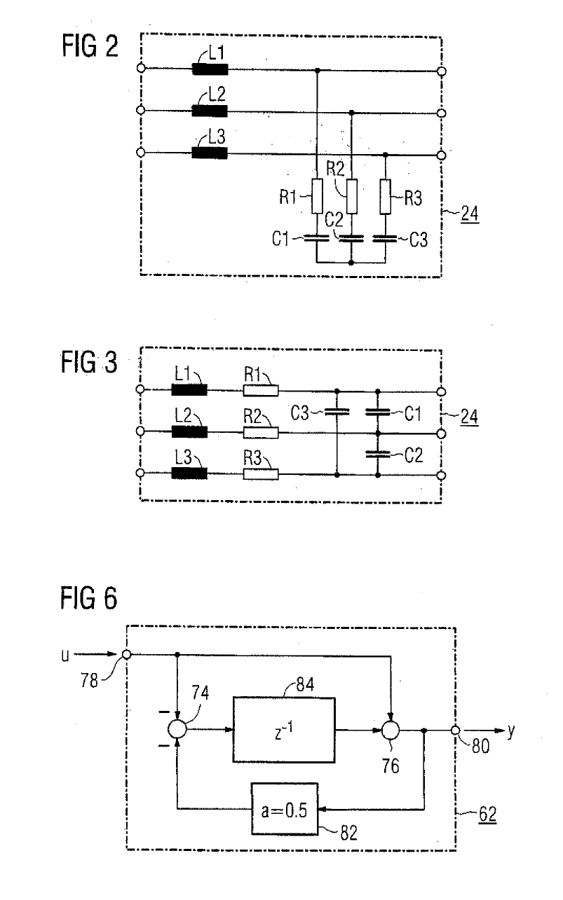

Turning now in particular to FIG. 4, there is shown an equivalent circuit of a drive comprising a converter 34 according to the invention, and an undamped inverter output-filter 36. FIG. 5 shows an equivalent circuit of this undamped output filter 36. This converter 34 according to the invention differs from the typical converter 2 shown in FIG. 1 by having a damping control circuit 38. This damping control circuit 38 is connected in an electrically conducting manner on the input side to the two outputs of the integrating current measuring device 4, and on the output side to the pulse width modulator 8. Since the damping control circuit 38 is connected to the pulse width modulator 8, the damping control circuit 38 intervenes by delaying either a rising or a falling edge of a respective pulse width signal. The respective other edge of this pulse width signal remains unchanged. This means that a delay to a switch-on edge (rising edge) of a pulse width signal results in a reduction in the voltage-time integral, whereas a delay in a switch-off edge (falling edge) of a pulse width signal results in an increase in the voltage-time integral. Reducing or increasing the voltage-time integral of a pulse width signal reduces or increases, respectively, an associated generated voltage amplitude. This intervention of the damping control circuit 38 has the advantage that the timing in module 8 is not critical.

FIG. 5 shows a more detailed equivalent circuit of a first embodiment of the damping control circuit 38. In this diagram, the control device 6 of the converter 34 and the load 26 are not shown explicitly for reasons of clarity. In addition, the load-side pulse-controlled inverter 10 together with pulse width modulator 8 has been replaced by three voltage sources 40, 42 and 44, which generate a respective voltage u_{L1}, u_{L2} and u_{L3}. In this diagram, the damping control circuit 38 is not connected on the output side to the pulse width modulator 8 of the load-side inverter 10, but to a superimposition device 46, to which a control variable u_{S}* generated by the control device 6 is also applied. Since resonant oscillation can occur in each inverter output phase, the damping control circuit 38 must also supply a correction signal u_{D1}, u_{D2} and u_{D3} for each inverter output phase. To make the superimposition device 46 as simple as possible, the control device 6 does not supply the generated control variable u_{S}* as a vector, but as phase signals u_{S1}* u_{S2}* and u_{S3}*. This means that the superimposition device 46 comprises just three adders 48, 50 and 52, to which are applied a respective phase signal u_{S1}*, u_{S2}* and u_{S3}* and a respective correction signal u_{D1}, u_{D2} and u_{D3}. The corrected phase signals u_{S1D}*, u_{S2D}* and u_{S3D}*, which are respectively present at an output of the three adders 48, 50 and 52, are then supplied to the pulse width modulator 8 of the load-side pulse-controlled inverter 10.

Of these three correction signals u_{D1}, u_{D2} and u_{D3}, only two correction signals u_{D1} and u_{D3} are generated directly by the damping control circuit 38. The correction signal u_{D2} is determined by means of an inverting adder 54, i.e. the following equation holds:
u_{D2}=−(u_{D1}+u_{D3})

As a result, the inverter output-filter 36 is not supplied by a zero phase-sequence system, and the two control paths (current control path, damping control path) thereby remain decoupled.

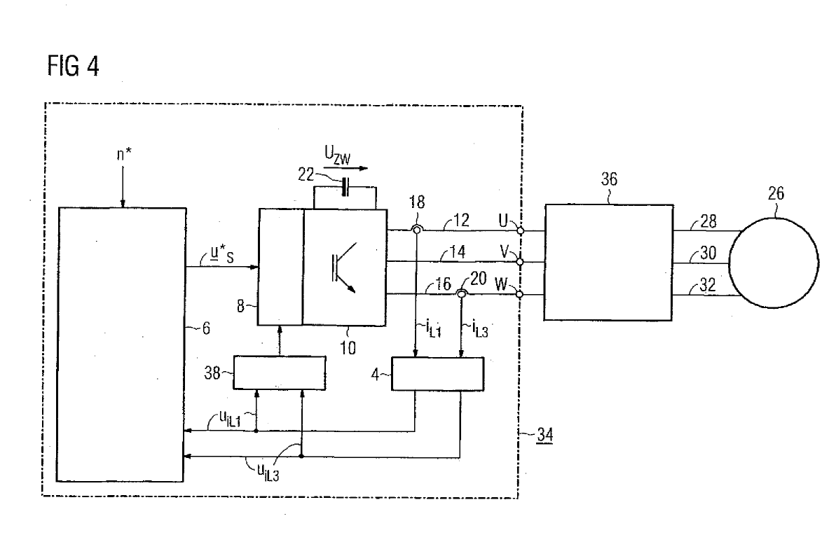

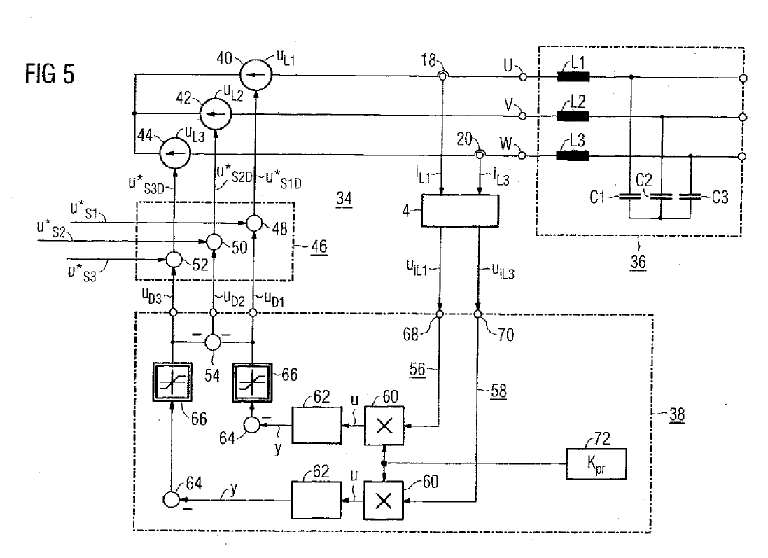

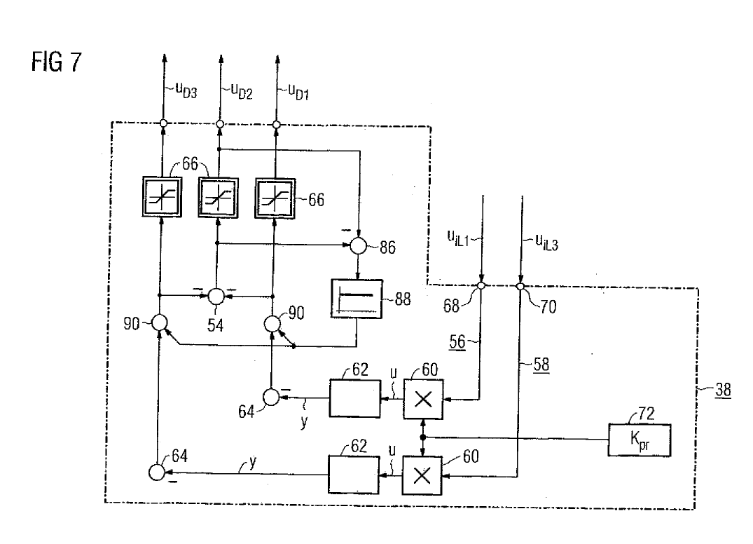

To generate the two correction signals u_{D1} and u_{D3}, the damping control circuit 38 comprises two control-circuit channels 56 and 58 of identical design. Each control-circuit channel 56 and 58 is connected on the input side to an output of the integrating current measuring device 4, and on the output side to an input of the inverting adder 54 and to an output terminal of the damping control circuit 38. Each control-circuit channel 56 and 58 comprises a multiplier 60, a controller 62, an inverting device 64 and a limiter 66. The multiplier 60 is connected on the input side to an input 68 and 70 respectively of the damping control circuit 38 and to an adjustable control loop gain factor generator 72, and on the output side to an input of the controller 62. This controller 62 is connected on the output side via the inverting device 54 to an input of the limiter 66, which is connected on the output side to an input of the inverting adder 54 and to an output of the damping control circuit 38. The design of the controller 62 is shown schematically in more detail in FIG. 6. The control loop gain Kₚᵣ can be set by the adjustable control loop gain factor generator 72 to a selectable value between zero and a maximum control loop gain Kₚᵣₘₐₓ. If the adjustable control loop gain factor generator 72 is set so that the value of the control loop gain Kₚᵣ is zero, the controllers 62 of the two control-circuit channels 56 and 58 of the damping control circuit 38 are disabled. If, on the other hand, the value of the control loop gain Kₚᵣ is set to a maximum value Kₚᵣₘₐₓ by the control loop gain factor generator 72, then the damping control circuit 38 is on the edge of stability. The value of the control loop gain Kₚᵣ to be set depends on the undamped LC filter 36 that is used and on a required damping level. Depending on a value of the control loop gain Kₚᵣ, a signal u is applied to the input of the controller 62 that equals the product of current-proportional signal u_{iL1} or u_{iL3} respectively and the control loop gain Kₚᵣ. This controller 62 generates from this controller input signal u a controller output signal y, which is applied in negated form to the input of the limiter 66. A correction signal u_{D1} or u_{D3} respectively is then present at the output of this limiter 66. The third correction signal u_{D2} is generated from these two correction signals u_{D1} and u_{D3}, which are determined directly by the control circuit, in such a way that the undamped LC filter 36 connected to the inverter 34 cannot be supplied by a zero phase-sequence system. To achieve this, the summation signal of the three correction signals u_{D1}, u_{D2} and u_{D3} must equal zero. This is achieved if the calculated correction signal u_{D2} equals the negative sum of the two correction signals u_{D1} and u_{D3} determined by the control circuit. Since the undamped LC filter 36 connected to the converter 34 is not supplied by a zero phase-sequence system, the two control paths, namely the current control path and the damping control path, remain decoupled. This is why the third correction signal u_{D2} must also be calculated after the limiters 66.

FIG. 6 shows a schematic diagram of an implementation of the controller 62. This controller 62 comprises an inverting adder 74 on the input side and an adder 76 on the output side. The input 78 of the controller 62 is connected to an input of the input-side inverting adder 74 and to an input of the output-side adder 76. This output-side adder 76 is connected on the output side to an output 80 of the controller 62. This output 80 of the controller 62 is connected via a weighting factor 82 to a second input-side inverting adder 74. The output of this inverting adder 74 is connected via a device 84 to a second input of the output-side adder 76. This device 84 has a transfer function z⁻¹. This means that this device 84 performs a pure delay by one sampling clock period. A synchronous parallel register produces such an effect. The output signal y of the output-side adder 76 is fed back to the second input of the input-side inverting adder 74 by the weighting factor 82. This controller 62 has the following transfer function:

$$H ( z ) = \frac{z - 1}{z + a}$$

The coefficients of the controller 62 equal 1 and a, where the coefficient a can assume any value between zero and one. The coefficient a is preferably selected to be 0.5. This means that the output voltage y of the controller 62 is multiplied by 0.5. In twos-complement arithmetic, multiplication by a=0.5 is an arithmetic shift by one binary digit to the right. The extent of this shift does not vary, which means that it can be implemented by direct wiring. This embodiment of the controller 62 means that it can be implemented in hardware. Programmable logic circuits or digital ASICs can be used for this hardware implementation. The hardware implementation of the controller 62 and hence also the damping control circuit 38 means that no additional dead time is produced.

The following difference equation shows how a controller input signal u applied to the input 78 of the controller 62 is processed:
y(k)=−0.5·y(k−1)+u(k)−u(k−1)

where k=sampling step
k−1=previous sampling step.

As soon as a current measurement value from the previous sampling step is present at the start of a new sampling step, this controller 62 supplies immediately after this a controller output signal y, which is superimposed as a correction signal u_{D1}, u_{D2} and u_{D3} respectively on a phase signal u_{S1}*, u_{S2}* and u_{S3}* respectively.

FIG. 7 shows an equivalent circuit of a second embodiment of the damping control circuit 38 in more detail. This second embodiment differs from the first embodiment shown in FIG. 5 by two limiters 66 being replaced by three limiters 66, a comparator 86, a proportional element 88 and two adders 90. Each adder 90 is connected to the output side of the inverting device 64 in a control-circuit channel 56 and 58 respectively. These two adders 90 are each connected on the output side to an input of the inverting adder 54. A second input of each of these two adders 90 is connected to an output of the proportional element 88, also known as a P element. A limiter 66 is connected to each output of the two adders 90 and of the inverting adder 54, the outputs of these limiters being connected to the outputs of the damping control circuit 38. The output of the inverting adder 54 is also connected to a non-inverting input of the comparator 86. The limiter 66 at the output of the inverting adder is connected on the output side to the inverting input of the comparator 86. As soon as the output signal of the inverting adder 54 exceeds the value of the output signal of the limiter 66, a signal appears at the output of the comparator 86, which is multiplied by the proportionality factor K_{PR}. A value of 0.5, for example, is provided as the proportionality factor K_{PR}. This output signal of the P element 88 is superimposed by means of an adder 90 on the output signal of the inverting device 64 of each control-circuit channel 56 and 58 respectively. This embodiment of the damping control circuit 38 ensures that the values of the correction signals u_{D1}, u_{D2} and u_{D3} can at most equal the limiter value of the limiter 66.

This damping control circuit 38 in the converter 34, which only uses the current measuring signals i_{L1} and i_{L3} that are present anyway, makes it possible to dispense with damping resistors R1, R2 and R3 in the LC filter 36 connected to the inverter 34, so that this LC filter 36 itself produces practically no more heat dissipation in normal operation. This also means that disadvantages no longer arise for the inverter 34 when this LC filter 36 is integrated in the inverter housing. In addition, LC filters 36 can be used in a star connection or Delta connection. The damping control circuit 38 remains stable even when the control variable is limited. Only the degree of damping is reduced when the limiter 66 comes into operation.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A converter comprising:
a control device having two input terminals and an output side,
a pulse width modulator having an input side connected to the output side of the control device;
a load-side inverter having control inputs connected on the output side of the pulse width modulator and an output side with three output terminals;
a current measuring device having an input side and an output side with two outputs, said input side connected to two of the three output terminals of the load-side inverter, said two outputs of the current measuring device being connected in one-to-one correspondence to two measurement inputs of the control device; and
a two-channel damping control circuit having two control-circuit channels with corresponding inputs and outputs, with each input of the control-circuit channel being connected to a different one of the two outputs of the current measuring device, and with the outputs being connected to an inverting adder, wherein the respective outputs of the two control-circuit channels and the output of the inverting adder are connected to corresponding inputs of the pulse width modulator.

2. The converter of claim 1, further comprising a superimposition device having first and second inputs and an output, wherein the respective outputs of the two control-circuit channels and the output of the inverting adder are connected to the first inputs of the superimposition device, wherein control outputs of the control device are connected to second inputs of the superimposition device, and wherein the output of the superimposition device is connected to the corresponding inputs of the pulse width modulator.

3. The converter of claim 1, wherein the two control-circuit channels of the damping control circuit each comprise a controller, a multiplier and an inverting device, wherein for each channel an output of the corresponding multiplier is connected to an input of the corresponding controller, and wherein a corresponding output of the controller is connected to a corresponding input of the inverting device, wherein each multiplier is connected with a first input to a corresponding input of the two-channel damping control circuit, and wherein second inputs of the multipliers are connected to one another and receive an input signal from an adjustable control loop gain factor generator.

4. The converter of claim 3, wherein each control-circuit channel comprises a limiter, said limiter being interposed between an output side of the corresponding inverting device and a corresponding input of the inverting adder.

5. The converter of claim 3, wherein each control-circuit channel comprises an corresponding adder having first and second inputs and an output, said first input of each adder being connected an output side of the corresponding inverting device and said output of each adder being connected a corresponding input of the inverting adder, and further comprising three limiters having inputs connected in one-to-one correspondence to the respective outputs of the two adders and to the output of the inverting adder, and a comparator having a first input connected to the output of the inverting adder and a second input connected to the output of the limiter that receives an input signal from the inverting adder, and an output which is connected to the second input of each of the adders.

6. The converter of claim 5, wherein a value of a proportionality factor produced by the control loop gain factor generator is equal to about 0.5.

7. The converter of claim 3, wherein the controller satisfies the following difference equation:
y(k)=−a·y(k−1)+u(k)−u(k−1) 0≦a≦1

8. The converter of claim 7, wherein the controller of each control-circuit channel of the damping control circuit comprises an adder, an inverting adder, a transfer function generator and a feedback device providing a weighting factor, wherein an input of the controller is connected to a first input of the inverting adder and to a first input of the adder, wherein an output of each controller is connected via the feedback device to a second input of the inverting adder, and wherein an output of the inverting adder is connected to an input of the transfer function generator, with an output of the transfer function generator being connected to a second input of the adder.

9. The converter of claim 8, wherein the transfer function generator comprises a synchronous parallel register.

10. The converter of claim 1, wherein the current measuring device is implemented as an integrating current measuring device.

11. The converter of claim 1, wherein the two-channel damping control circuit is implemented in hardware.

12. The converter of claim 11, wherein the two-channel damping control circuit comprises at least one programmable logic circuit.

13. The converter of claim 11, wherein the two-channel damping control circuit comprises at least one ASIC.

14. The converter of claim 11, wherein the two-channel damping control circuit comprises a signal processor.
